(19) United States
(12) Patent Application Publication
(10) Pub. No.: US 2016/0192588 A1
(43) Pub. Date: Jul. 7, 2016

(54) Operating Assembly for Harvesting

(71) Applicant: Stanley Benjamin Smith, Charlotte, NC (US)

(72) Inventor: Stanley Benjamin Smith, Charlotte, NC (US)

(21) Appl. No.: 14/995,303

(22) Filed: Jan. 14, 2016

(51) Int. Cl. A01D 46/00; A01D 75/00; A01D 46/22

(52) U.S. Cl. CPC A01D 46/005; A01D 46/22; A01D 75/00; A01D 2101/00

(57) ABSTRACT

An operating assemblage to harvest agricultural crops at a peak of ripeness comprising a mobility component configured to navigate through an agricultural field; at least one vacuum motor calibrated to generate necessary and sufficient suction to successfully harvest a harvestable ripe unit of a crop such as a fruit, berry, nut, or vegetable using a collection hose ending in a collection nozzle of a size appropriate to the crop; the collection nozzle housing an array of sensors; and a collection and storage receptacle for harvested produce. The assemblage is configured by an operator inputting parameters to calibrate the array of sensors to trigger the vacuum motor to apply sufficient suction to harvest agricultural produce at a specified degree of ripeness. Components of the operating assemblage are connected to a power source responsive to real time communication via an electronic device equipped with at least one Wi-Fi chip set or Bluetooth capability.

### FIELD

The present specification generally relates to an operational assemblage to selectively harvest agricultural crops.

### BACKGROUND OF THE INVENTION

Labor costs for harvesting crops constitute a major expense for farmers. There is much interest in reducing labor costs by means of mechanical harvesting.

Mechanical harvesting has usually been achieved through use of combs or rakes in various configurations. The combs or rakes come into contact with crops and capture and channel them; often into a receptacle. These systems and methods pose liabilities; particularly damaging the crops and harvesting both ripe produce and unripe crops in the same operation. There is a need for a harvesting method that addresses the liabilities of current systems and methods.

### SUMMARY

Art is provided, described, explained, and illustrated for an operating assemblage that mechanically harvests crops from their growth media. The art includes both a system and a method. The system links a power source to multiple vacuum motors, each of which is connected to a collection hose. The collection hose ends in a nozzle assembly equipped with an array of sensors. The hose transmits the force of suction from a vacuum motor to pull at least a single crop item from growth media through a collection hose that meets the requirement for harvesting as specified by an operator and measured by an array of sensors in a crop facing nozzle at the end of the collection hose to detect ripeness. The end of the collection hose is encased in a nozzle assembly sized for units of the crop and includes at least one sensor to detect parameters and degrees of ripeness as the collection nozzle assembly comes into sufficiently close proximity with the growth media. The sensors are connected to an electronic processor via a Wi-Fi direct multi-channel and multi role capability chip set or by electric conduction wires connected to the electronic processor. The electronic processor is also connected to a power supply sufficient to drive the vacuum motors and other components of the operational assemblage, such as a mobile unit.

The system arranges collection receptacles for crops channeled through one or more sensor equipped collection nozzle assemblies on collection hoses arranged and stabilized along a horizontal heavy duty adjustable tension rod. Collection receptacles are seated and stabilized on a mobility device. The collection hoses are positioned to come into sufficient proximity with growth media as the mobile unit traverses the path between crops to enable the sensors to detect ripeness of individual units of a crop. The collection hoses, at intervals along the horizontal heavy duty adjustable tension rod, are positioned to hang downward sufficiently to enable a collection nozzle to partially encase at least one unit of a crop as the operating assemblage traverses the terrain. The collection hoses are of sufficient rigidity to enable forward or backward motion of the mobile unit to pull them through the growth medium, thus enabling the collection nozzle to come into sufficient proximity with the crop for electronic sensors embedded in them to assess ripeness and trigger wireless signals to an electronic processer for the electronic processor to signal a vacuum motor to generate necessary and sufficient suction for a unit of a crop of sufficient ripeness to be collected and channeled into a collection receptacle.

The method of the invention uses the operational assemblage to harvest crops; such as fruits, berries, vegetables or nuts. As the mobile unit carries the operating assemblage through a path between rows of growth media and the collection hoses with their attached crop facing nozzle assemblies contact growth media on each side of row or path, the collection nozzles enable the sensors housed in the nozzle assemblies to come into sufficient proximity with a fruit, berry, vegetable or nut to assess the ripeness of individual units of produce. When a ripe fruit, berry, vegetable or nut is detected, the vacuum motor suctions the ripe produce and channels it into a curved deflection path, then into a channeling chute, and then into a drop pipe positioned over a collection receptacle. While the fruit, berry, vegetable or nut traverses the collection hose and the channeling chute to the drop pipe they are separated by properties of gravity and bounce into firmer and softer produce, with the firm produce being routed into a portion of the collection receptacle containing for ripe produce. In the case of a large mobile unit, the collection receptacle houses a shelf stack of lugs set at a 45 degree angle with the front panel open to receive the fruit, berry, vegetable or nut.

The soft fruit, berry, or vegetable can be routed into a separate section of a collection receptacle because the amount of moisture and other properties of overripe fruits, berries or vegetables cause them to move through the hose and chute and drop pipe at a slower rate. When the operating assemblage has completed the collection process, the assemblage is routed to an unloading facility. Operators also remove the overripe fruit, berry, or vegetable section of the collection receptacle. The collection receptacle is reloaded with empty lugs and an empty overripe fruit, berry, or vegetable section. In some embodiments, the power source for the operational assemblage is then recharged. In some embodiments the operational assemblage is then cleaned or serviced. The operational assemblage is then routed to collect produce from another section of the farm.

A sub-system of the operational assemblage enables the onboard processor to transmit and receive Wi-Fi signals to and from a mobile communications device. A GUI on the mobile communications device is used by an operator to configure the functions of the operating assemblage and the parameters of the collection method.

### DESCRIPTION

### Brief Description of the Drawings

FIG. 1a is a schematic side elevation view of an example of the operating assemblage in use, carried by an autonomous mobile unit with no human operator;

FIG. 1b is a schematic side elevation view of an example of the operating assemblage in use, carried by a mobile unit with two operators;

FIG. 1c is a schematic side elevation view of an example of the operating assemblage in use, carried in a mobile unit directed by a single operator;

FIG. 1d is a schematic side elevation view of an example of the operating assemblage in use, carried in a backpack by an operator;

FIG. 2a is a view of the operating assemblage of FIG. 1a illustrating a telescoping tension rod and a collection hose;

FIG. 2b is a view of the operating assemblage showing motors and housing in relation to a collection hose;

FIG. 3a is a perspective view showing connections of motors and power sources to a collection hose;

FIG. 3b is a perspective view showing a frontal view of a berry collection nozzle and array of sensors and other electronic components;

FIG. 4a is a side view of the horizontal heavy duty adjustable tension rod seated in the atop a set of berry collection receptacles and showing how berry collection tube bundles can be channeled along the horizontal heavy duty adjustable tension rod;

FIG. 4b is a side view of the mobile unit with a tow bar towing a second operational assemblage;

FIG. 5 is a side view showing the connection of three vacuum motors and three berry collection tubes feeding into a berry channeling chute;

FIG. 6a is a schematic of electronic links of components of the operational assemblage FIG. 6b is a side view of electronic links of sensors to components of the operating assemblage;

FIG. 6c is a set of GUI screens for a mobile device for setting parameters for operation of the operating assemblage.

### DETAILED DESCRIPTION OF THE INVENTION

A definition we offer for the term “growth media” as it relates to this specification is “any plant, bush, shrub or tree.” A definition we offer for the term “produce” is a crop of “any fruit, nut, berry, or vegetable harvested from growth media.” A definition we offer for “produce” is “any intentionally harvested fruit, nut, berry, or vegetable.” A definition we offer for a “collection nozzle” is “any configuration of a nozzle appended or attached to the end of a hose that can be placed in sufficiently close proximity to a fruit, nut, berry, or vegetable to enable vacuum suction to overcome the tensile strength of the connection of the produce to its growth medium.” A “nozzle assembly” is a collection nozzle equipped with at least one sensor. Other terms should be familiar to those of ordinary skill in the art and reference to standard dictionaries should be sufficient for clarification.

There are multiple sets of activities involved in using an operational assemblage to harvest ripe agricultural produce:
1. Configuring the operation of the sensors and mechanical components;
2. Traversing rows of growth media;
3. Engaging with a single unit of growth media, such as a plant or bush or tree or section of ground;
4. Selecting a unit of a fruit, berry, vegetable or nut;
5. Moving collected units of ripe fruit, berries, vegetables or nuts undamaged into a collection receptacle;
6. Moving a receptacle filled with produce to a location for unloading and shipping;
7. Recharging or reconnecting portions of the operation assemblage to a power source;
8. Cleaning or servicing portions of the operational assemblage;
9. Refilling the collection receptacle with lugs or other forms of transportable produce storage.

Embodiments of the invention disclosed herein use an electronic processor connected to a chip set with Wi-Fi direct multi-channel and multi role capability or Bluetooth capability to communicate with one or more Wi Fi or Bluetooth capable sensors housed in a collection nozzle assembly attached to a produce collection hose. Alternate embodiments requiring alternate types and numbers of sensors can be implemented if a human operator manually directs the collection hose to enable the collection nozzle at the end of a sufficiently rigid or sufficiently flexible collection hose to partially surround or encase the fruit, berry, vegetable or nut selected by the operator. Some embodiments will use wireless signaling to the collection hose based on input from one or more sensors to direct the collection hose mechanically using spatial and proximity algorithms. The mechanical components of the operating assemblage can be configured as a series of default settings to be adjusted via artificial intelligence algorithms or set by a human operator using multiple setup screens of a GUI on a mobile electronic communication device equipped with an electronic processor. Figures illustrating the invention show screens on a mobile phone as an example of a human operator arranging mechanical components. Motorized arrangement of mechanical components will drive pulleys and gears using supplemental motors connected to a power source. It can be assumed by a person of ordinary skill in the art that an embodiment that uses motorized adjustment of mechanical components will include an operator using a mobile communication device to use Wi-Fi or Bluetooth communication protocols to further calibrate the motors and to set the parameters and positioning of mechanical components.

The invention disclosed herein offers alternative mobility methods to transport the operational assemblage to harvest produce through paths between growth media in a farming operation. These alternative mobility methods lend themselves to different price points and allocations of labor resources and are expected to be used by farmers according to their degree of capitalization, their ownership of different numbers of acres under cultivation, and their cost benefit assessments for use of a particular embodiment for a specific crop. It will be understood by those of ordinary skill in the art of the invention that the mobility methods can be combined, adjusted, and reconfigured in alternative embodiments and are not rigorously restricted by the acreage under cultivation. It will be further understood that the produce collection receptacle can be readily separated from a mobility option for servicing and for placement onto an alternative mobility format. The collection components of the operation assemblage can further be separated from the collection receptacle.

Mobility methods of alternate embodiments include:
Placing the operational assemblage onto an autonomous robotic mobile unit with GPS capability with no human operator on board.
Placing the operational assemblage onto a mobile platform to be pulled along by a human operated tractor. A variant of this method is for the tractor to be configured to be an autonomous vehicle, eliminating the need for an onboard human operator.
Placing multiple human operators on a vehicle who manually direct the collection hoses into growth media.
Providing one human operator with a mobile unit to carry an operational assemblage with one or two collection receptacles. As the operator directs the mobile unit, he also directs the collection hoses into growth media.
Providing one human operator with a backpack frame outfitted to carry a single collection receptacle as the human operator walks through growth media.

Some alternative embodiments will place the operational assemblage onto a wheeled platform that can be carried or towed by a vehicle, such as a tractor. A series of operating assemblages can be linked together to be towed by a powerful vehicle equipped with a tow bar in cases where massive harvesting of produce from growth media laden with fruits, berries, vegetables or nuts, or when harvesting most of the produce in a single pass is necessary. Alternative embodiments can be configured to mount the operational assemblage on a two or three wheeled mobile unit, such as a golf bag carrier. Another embodiment mounts two operational assemblages onto a vehicle; such as a golf cart, enabling two human operators to each direct the sensor equipped collection nozzle of a collection hose into growth media to suction up produce. The number of collection hoses can be reduced to as few as one. Alternate embodiments also include the operational assemblage built into a vehicle as the vehicle is manufactured.

The invention disclosed herein considers two methods and sets of components for the operational assemblage to engage growth media;
A series of collection hoses are pulled by a motorized vehicle positioned for the nozzles to rake through a growth media and encounter clusters or individual fruits, berries, vegetables or nuts.
A human operator directs a collection hose into close proximity with a cluster of fruits, berries, vegetables or nuts or an individual unit of produce.

The invention disclosed herein offers methods and components for using sensors in an operational assemblage to assess which fruit, berry, vegetable or nut attached to a growth medium is at an appropriate stage of ripeness for picking.

The invention disclosed herein offers methods and components for the operational assemblage to;
Utilize vacuum suction to pull a selected produce, such as a fruit, berry, vegetable or nut from the growth media via a collection nozzle sized appropriately for the fruit, berry, vegetable or nut,
Channel the fruit, berry, vegetable or nut to be discharged into a collection receptacle,
Channel the fruit, berry, vegetable or nut into a standard field container (usually called “lug”) that is then transported or shipped,
Separate soft produce (such as an overripe berry) from firm produce so the lugs contain only firm produce and the soft produce is channeled into a separate container.

The invention disclosed herein offers methods and components for the operational assemblage to load produce into lugs housed in a collection receptacle.

The invention disclosed herein offers methods and components of an operational assemblage that include electronic communication using a Wi-Fi chipset with Wi-Fi direct multi-channel and multi role capability linked to a processor in a housing proximal to a collection receptacle to set up or configure:
a. Parameters for sensors to register ripeness of a unit of produce
   i. Upon a color, chemical, moisture or other sensor determining sufficient ripeness of a unit of produce, the sensor signals the processor to start a vacuum motor to suction the unit of produce through the collection hose and into a collection receptacle
   ii. Upon a light sensor determining an insufficiency of ambient light for proper calibration of color, and therefore ripeness, signaling the processor to turn on a light source proximal to the nozzle assembly to enable an operator and the color sensor housed within the nozzle assembly to accurately assess the presence of a ripe unit of produce in a cluster
   iii. A weight sensor housed in a collection receptacle sensitive enough to register each additional unit of produce will signal the processor to add the additional unit to a count of units.
   iv. Computer readable instructions read by the electronic processor can also calculate the time a unit of produce takes to traverse the collection hose into the collection receptacle by calculating the length of time from the ripeness sensor triggering the processor to start the vacuum motor and the weight sensor in the collection receptacle registering the additional unit of produce. This calculation of the speed of collection of a unit of produce is convertible to a measure of tensile strength of the connection of the produce to the growth media. Different varieties of produce and different stages of ripeness are reflected by the strength of the tensile connection of a unit of the produce to the growth medium.

There are significant benefits to continuous measurement and feedback loops enabled by the use of sensors within the operating assemblage. A farmer is always calculating and apportioning his available labor to harvest his produce. He is also calculating the ideal degree of ripeness of his produce for his particular marketing and distribution purposes; such as days between shipment and arrival at a shipping destination, or a degree of ripeness for immediate processing into value added products. When the tensile strength calculation is compared against the ripeness requirement, the operator or computer readable instructions can instruct the electronic processor to implement a signal for an adjustment to the amount of suction power delivered by the vacuum motor, with the caveat that produce riper than the ideal degree of ripeness are also captured. If the tensile strength of connections of produce to growth media is too strong to trigger the vacuum motor to initiate suction, the operator may determine that the operating assemblage should be brought back to the home base or routed to a different set of rows.

Also optionally attached to the collection nozzle as part of the assembly is a live streaming video camera to display a view of the harvesting process.

In embodiments of the invention utilizing mechanized transportation of the operating assemblage by mobile units, the tops of the collection receptacles that support the channel for the horizontal heavy duty adjustable tension rod will be higher than that of the growth media. The width of the tension rod will be adjustable by an operator or by algorithms calculating the speed of collection of units of produce. The telescoping capacity of both sides of the horizontal heavy duty adjustable tension rod will be responsive to instructions to accommodate the spacing between rows of growth media. Mobile units in various embodiments will be configured and sized to traverse the spaces between rows.

Sensor data also informs the spacing of the collection hoses on the horizontal heavy duty adjustable tension rod. If a number of units of growth media traversed by the operating assemblage yields a specific count of produce in a unit of time that fails to correlate with a default standard, the processor signals the motors in the telescoping horizontal heavy duty adjustable tension rod to shift right or left one measurement unit. After a large enough sample number of growth media have been traversed, the processor calculates ideal position of the collection hoses on the horizontal heavy duty adjustable tension rod for collection of the largest number of units of ripe produce. Variance in embodiments of the invention of the distance between the collection hoses on each side of the horizontal heavy duty adjustable tension rod and numbers of collection hoses is dependent on the configuration best suited to the growth media and spacing of rows. Continuous and real time sampling will enable the operating assemblage to adjust to variance in the configuration of rows and variance in the height and width of growth media if the field is planted with more than one variety of produce.

The flexibility of branches and stems and leaves of the growth media will vary according to the crop and the age of the growth media. A calculation of the count from all the collection hoses as against a timeline for a sample number of units of growth media traversed compared against the current single unit of growth media will result in an estimate of the time the collection hose should be in contact with the following or upcoming unit of growth media. This calculation will be performed by the onboard processor and continuously transmitted to the acceleration and steering system of the mobile unit, instructing the mobile unit to speed up or slow down to achieve an optimal speed for pulling the collection hose through a unit of growth media. The onboard processor can use the same sampling method and calculation to adjust the steering mechanism of the mobile unit, moving the mobile unit laterally within the path between two rows of growth media so the collection nozzles come into contact with more of the growth media. This combination of adjustment to forward speed and use of lateral motion in combination will enable the operating assemblage to maximize the harvest of ripe produce. It should be noted that this is a feature of the fully mechanized robotic embodiment. A person of ordinary skill in the art will understand how a human operator can adjust speed and lateral motion of the mobile unit in alternative embodiments.

One embodiment of the invention will enable an operator to manually adjust spacing of collection hoses along the horizontal heavy duty adjustable tension rod by using snap locks to push or pulling the telescoping cylinders into the desired configuration. An alternative embodiment enables a remote operator to use the GUI on a Wi-Fi enabled mobile communication device to implement motorized lengthening or contracting of the telescoping cylinders of the horizontal heavy duty adjustable tension rod as he responds to a real time streaming video image of the harvesting process.

In alternate embodiments of the invention, the conversion of the vacuum motor into a blower enables expulsion of debris and twigs from the collection hoses. This embodiment will enable a horticulturalist to walk the rows of growth media to examine small piles of expelled debris and diagnose diseased soil and diseased plants, catalog the insects in the field and assess other risks to crops.

In comparison to prior art for harvesting, this operating assemblage will collect more produce of the appropriate degree of ripeness, damage less produce, separate ripe produce from unripe produce, and place produce into lugs for ready sorting distribution and shipment.

When the rows of growth media have a high number of ripe units of produce, the lower the speed of the mobile unit or movement of the mobile unit into reverse and forward several times as it traverses the growth media to fill collection receptacles will result in a satisfactory amount of harvested produce in fewer passes through rows of growth media.

In alternate embodiments a single large vacuum engine can be substituted for multiple vacuum motors for farmers with supplemental produce sorting equipment, making the onboard produce sorting capability redundant. In this configuration, the use of sensors becomes secondary and the use of vacuum power to harvest masses of produce moves to the fore. This embodiment reduces the ecological advantage of using the invention to limit wastage, but this capability can be important when conditions such as weather shifts speed up the ripening process or access to the growth media is physically blocked for a time.

In alternate embodiments, the size of the collection hose, the size of the collection nozzle casing, the configuration and placement of sensors within the nozzle assembly and the number of vacuum motors can be adjusted to accommodate the need to partially encase different varieties and species of produce. Alternate configurations and arrangements of both collection hoses and the nozzles upon the collection hoses in circular or linear fashion or stack arrangements in a single layer or multiple layers will further enable collection of produce to be adapted to specific varieties and species of produce.

Embodiments will utilize alternate guidance subsystems to adapt to different navigation paths for the mobile unit carrying the operating assemblage. Embodiments will also vary in the configuration and placement of the horizontal heavy duty adjustable tension rod for a particular growth media. Different configurations of ripeness sensors and counters can be implemented for the operating assemblage as the type of crop and layout of the field changes.

The operational assemblage is well suited to produce from ordered rows of growth media, however it will be understood those of ordinary skill in the art that the assemblage can be adapted to a variety of planting configurations and terrain. An example of an alternate embodiment using the operational assemblage for collection of produce growing in terrain not traversable by a conventional wheeled mobile unit is the use of a drone as the mobility unit. In this embodiment, a drone is outfitted with the electronic processor and vacuum motors and collection hoses with sensor equipped collection nozzle assemblies. The drone is equipped with a hamper to carry smaller amounts of produce to a collection receptacle placed nearby. When the hamper on the drone is full, as measured by a weight sensor in the hamper, the drone flies to the nearest collection receptacle and empties the hamper into the collection receptacle. In this embodiment, the separation of overripe from ripe produce is not practical, but use of other features and benefits of the collection receptacle remain practical and applicable. This embodiment is particularly well suited to picking currents, cranberries or wild blueberries where terrain is craggy and hilly and inaccessible to wheeled mobility options. It should be noted that many desirable crops grow in terrain that is difficult to configure for row planting, but still can be harvested by vacuum suction sufficient to overcome the tensile connection of the individual unit of produce to the growth medium or plant stem. Wild mushrooms are an example of a candidate for implementation of this embodiment.

In a large scale embodiment, multiple collection hoses are spaced along the horizontal heavy duty adjustable tension rod. The relative spacing of the collection hoses can be adapted to the actual rows of growth media. The operating assemblage, in alternate embodiments, will vary the position of parts of the assemblage. Fewer or more parts will be included into different embodiments. Therefore, the examples described above and illustrated in the figures are intended to be exemplary only. The scope of the invention is intended to be determined by the appended claims.

Parts of the operating assemblage
1. power source—a large rechargeable battery or a gasoline fueled generator or a hard wired alternating current connection
2. mobile unit with a connection to an external power source or a power source within the unit
3. heavy duty adjustable tension rod that extends or telescopes at each end—the use of telescoping enables positioning of the collection hoses in relation to the farmer's spacing of the growth medium for the crop
4. platform to seat and stabilize collection receptacles on a mobile unit
5. seating to stabilize the horizontal heavy duty adjustable tension rod
6. housing unit to house vacuum motors and wiring to connect the vacuum motor to collection hoses and produce channeling chutes
   a. a power source
   b. a wireless signaling processor
   c. a produce channeling chute
7. platform to seat and stabilize the housing for vacuum motors
8. food grade produce collection hose
9. GPS receiver
10. ripeness sensors in the collection nozzle assembly housing or case
   a. for color saturation and hue
   b. for chemical signatures or indicators of ripeness
   c. for moisture content of a unit of produce
11. weight sensors
   a. one to be placed under each ripe produce receptacle to assess the volume of produce loaded into the receptacle
   b. one to be placed under each overripe produce container to assess the volume of overripe produce
12. light sensor to signal a light source to turn on in order for the color and hue sensor to get an accurate measurement of color and light
13. timing sensor to sense the time between discovery by a ripeness sensor of a ripe unit of produce and the passage of the unit of produce through a collection hose. This will be used in calculating the tensile strength of connections of units of produce to their growth media
14. counting sensor
15. light source to place on or in a berry collection nozzle assembly
16. nozzle with a portion configured to face and partially encase the growth medium to be placed at the end of a collection hose to house ripeness sensors, light sensors, timing sensors, and weight sensors to wiring to connect sensors to the processor
17. chips with Wi-Fi direct multi-channel and multi role capability to link said sensors to an electronic processor via direct wired connections or Wi-Fi or Bluetooth signals
18. miniature Wi-Fi direct multi-channel and multi role capability enabled video camera to affix to a collection nozzle to enable a remote operator to visually determine how the produce harvesting process is functioning
19. electronic processor able to accept electronic signals from sensors linked to a Wi-Fi direct multi-channel and multi role chip set
20. housing unit for an electronic processor and wiring to connect to sensors and a vacuum motor
21. Wi-Fi enabled communication processor (a smart phone) able to transmit configuration instructions to and from a Wi-Fi direct multi-channel and multi role chip set
22. vacuum motor
   a. configured as a shunt engine or attached to a rheostat responsive to calibration instructions for the amount of suction power
   b. reversible to operate as a blower
   c. connected to a power source
   d. connected to a collection hose to suction produce into the collection hose and blow out debris trapped in a collection hose
23. channeling chute to direct suctioned produce from the collection hose and enable gravitational separation of firm produce from overripe produce before being routed through a drop pipe
24: hyperspectral camera
25: Bluetooth or NFC or Wi Fi enabled motor connected to gears that ratchet the adjustable tension rod
26: tow bar
27. drop pipe with a lip to enable ripe and overripe produce to fall into separate containers
28. collection receptacle divided into a section to accept firm produce and a section to accept soft overripe produce as it falls through the drop pipe with less momentum
29. slide out rack support to house lugs within the collection receptacle
30. lugs to fit into the collection receptacle with front panels that can fold down and the fold under the lug to leave an opening for produce to fall into the lug within the collection receptacle. The front panel of the lug can be folded back up and snapped into place prior to being removed from the lug rack in the collection receptacle
31. pairs of slide guides on the rack support placed at a 45 degree angle to hold lugs in position to accept produce from the produce drop pipe
32. wheeled platform to support a second operating assemblage

### DESCRIPTION OF THE FIGURES

Further features and advantages will become apparent from the appended figures, in which:

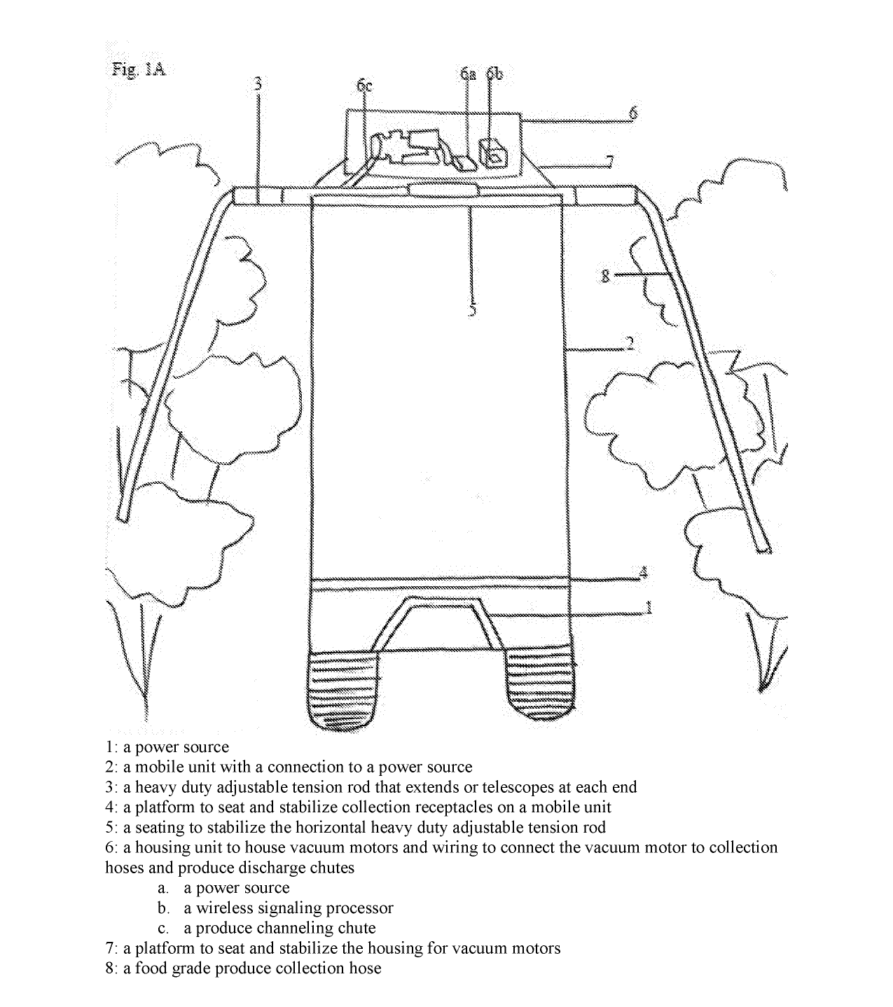

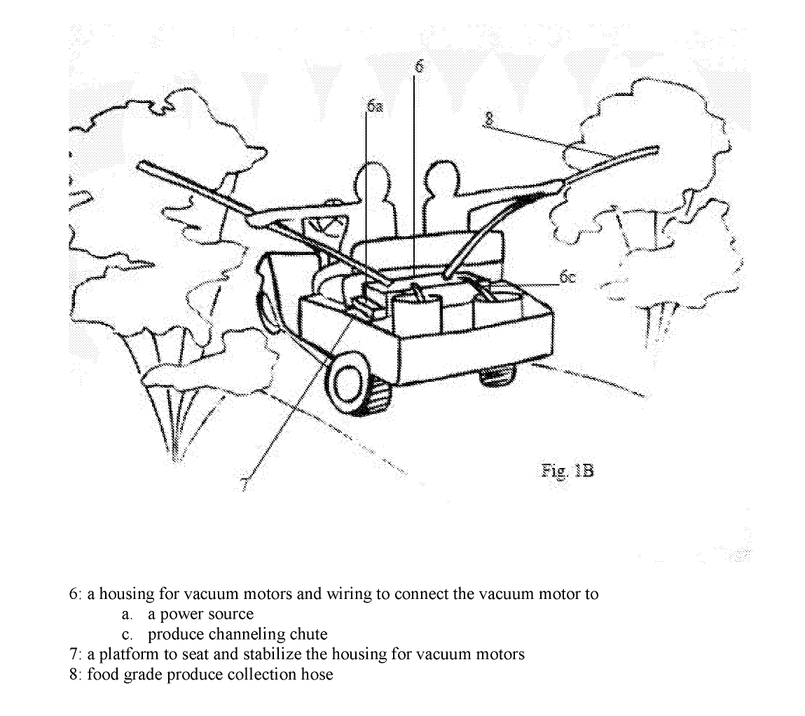

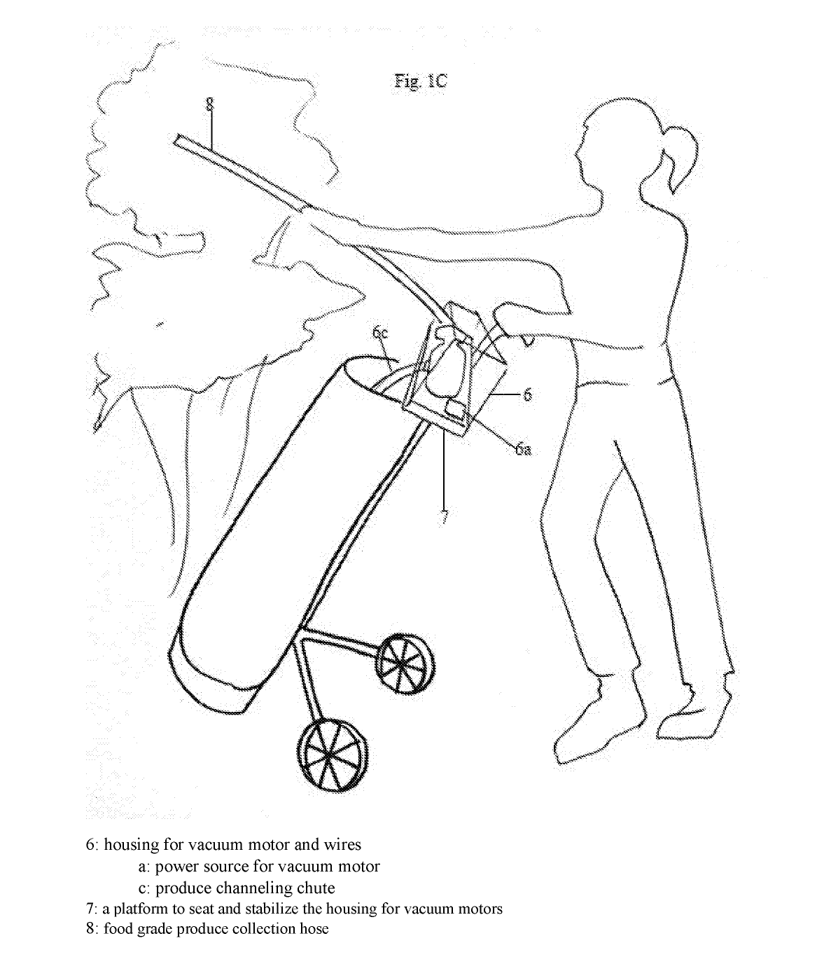

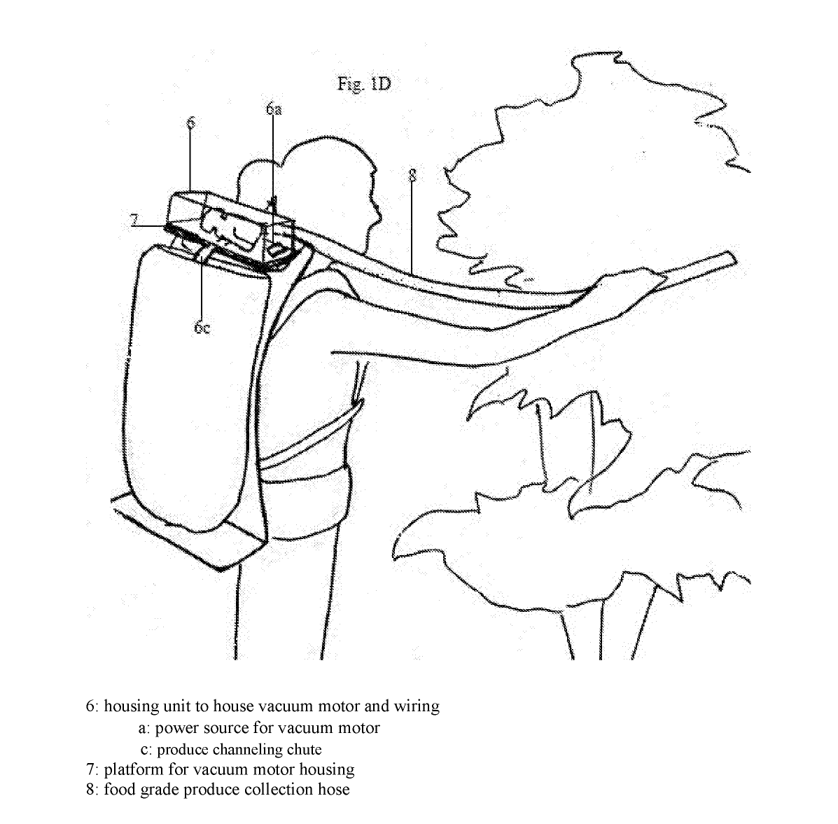

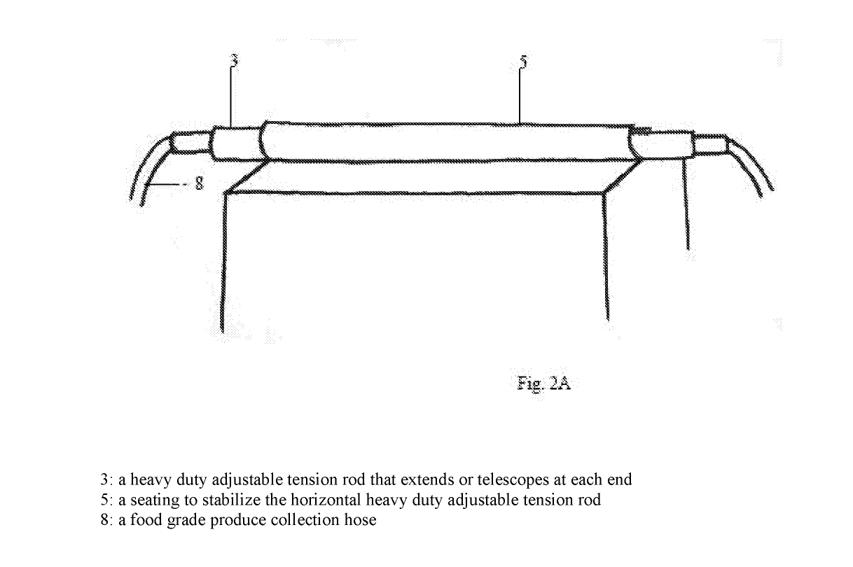

FIG. 1a is a schematic side elevation view of an example of the operating assemblage in use, carried by an autonomous mobile unit with no human operator;

FIG. 1b is a schematic side elevation view of an example of the operating assemblage in use, carried by a mobile unit with two operators;

FIG. 1c is a schematic side elevation view of an example of the operating assemblage in use, carried in a mobile unit directed by a single operator;

FIG. 1d is a schematic side elevation view of an example of the operating assemblage in use, carried in a backpack by an operator;

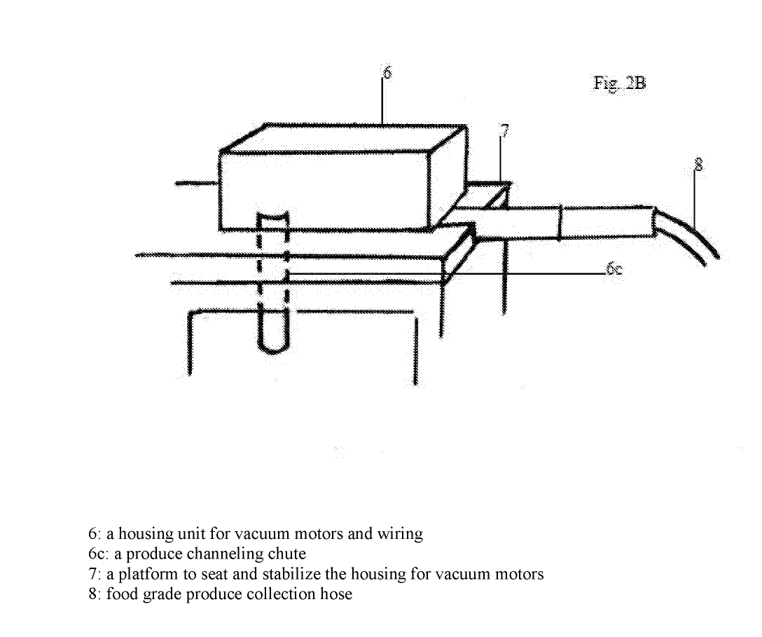

FIG. 2a is a front perspective view of the operating assemblage of FIG. 1a with a collection hose;

FIG. 2b is a front perspective view of the operating assemblage using 1 collection hose;

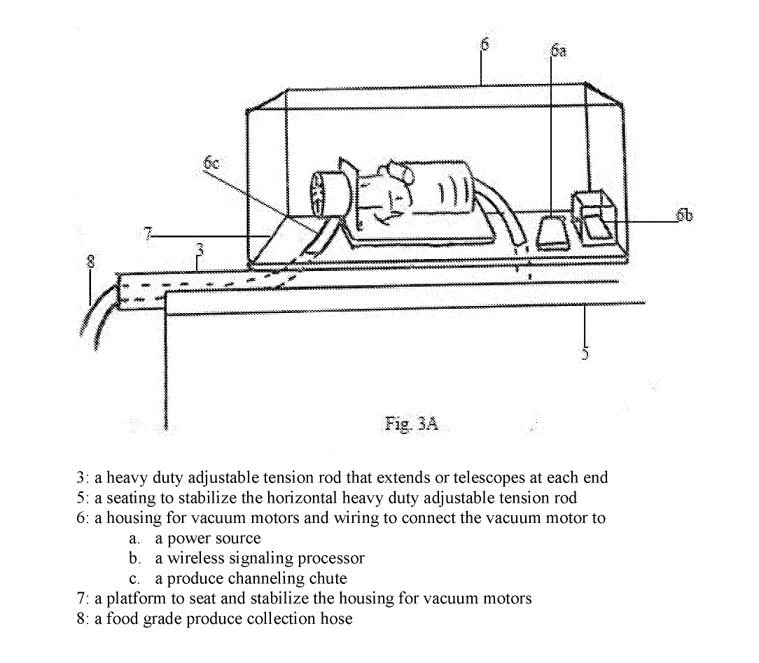

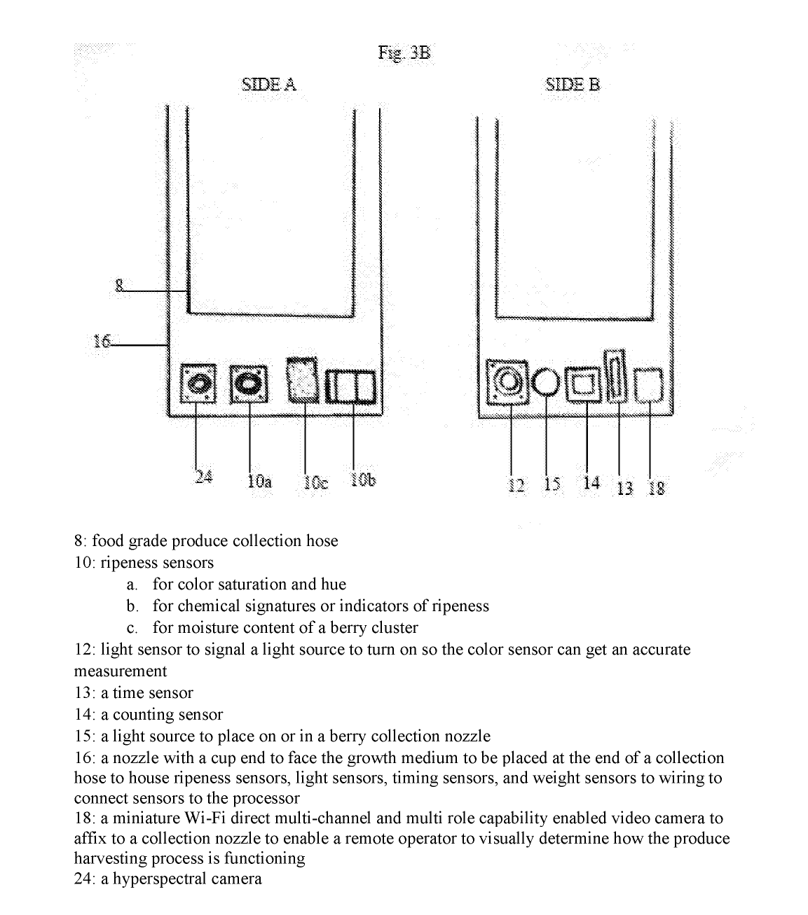

FIG. 3a is a perspective view showing a collection nozzle assembly in greater detail;

FIG. 3b is a perspective view showing a frontal view of a collection nozzle assembly with an array of sensors, the video camera, and a light source;

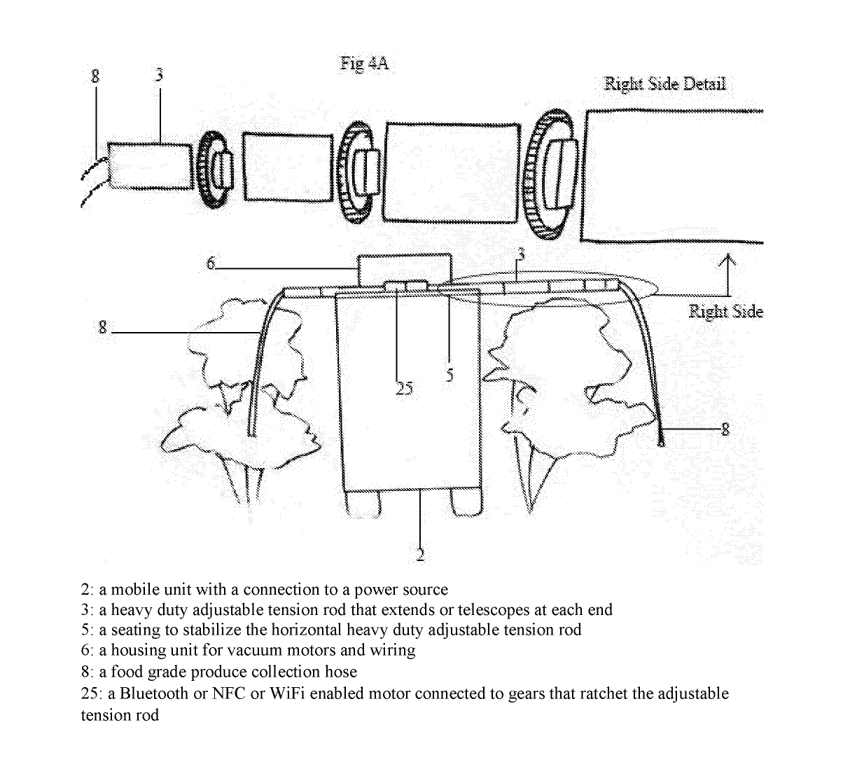

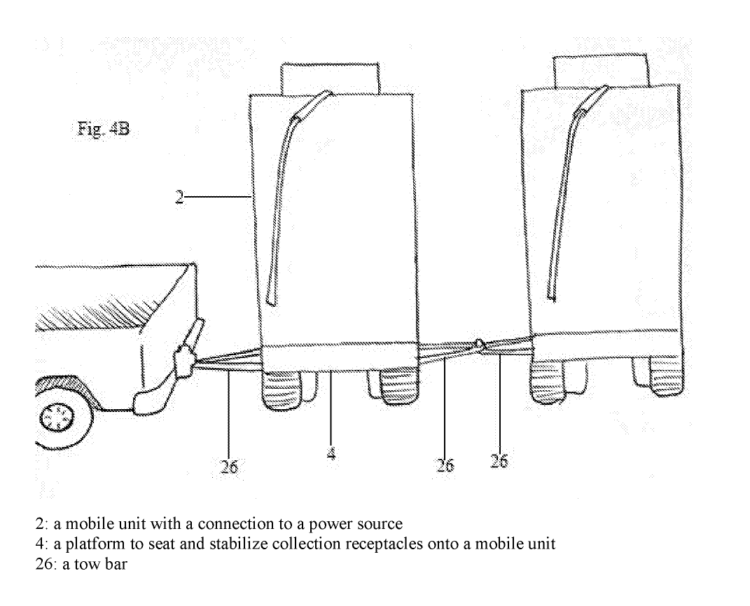

FIG. 4a is a side view of the horizontal heavy duty adjustable tension rod seated in the atop a set of collection receptacle and showing how collection hoses can be channeled along the horizontal heavy duty adjustable tension rod;

FIG. 4b is a side view of the mobile unit with a tow bar towing a second operational assemblage;

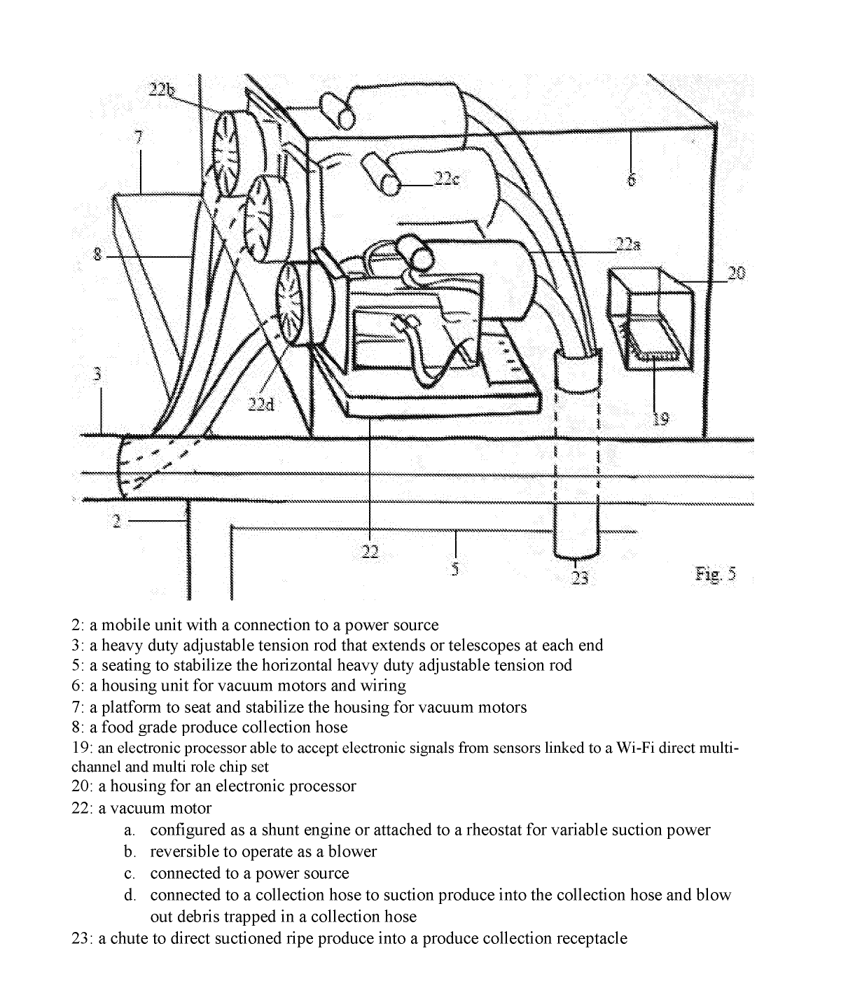

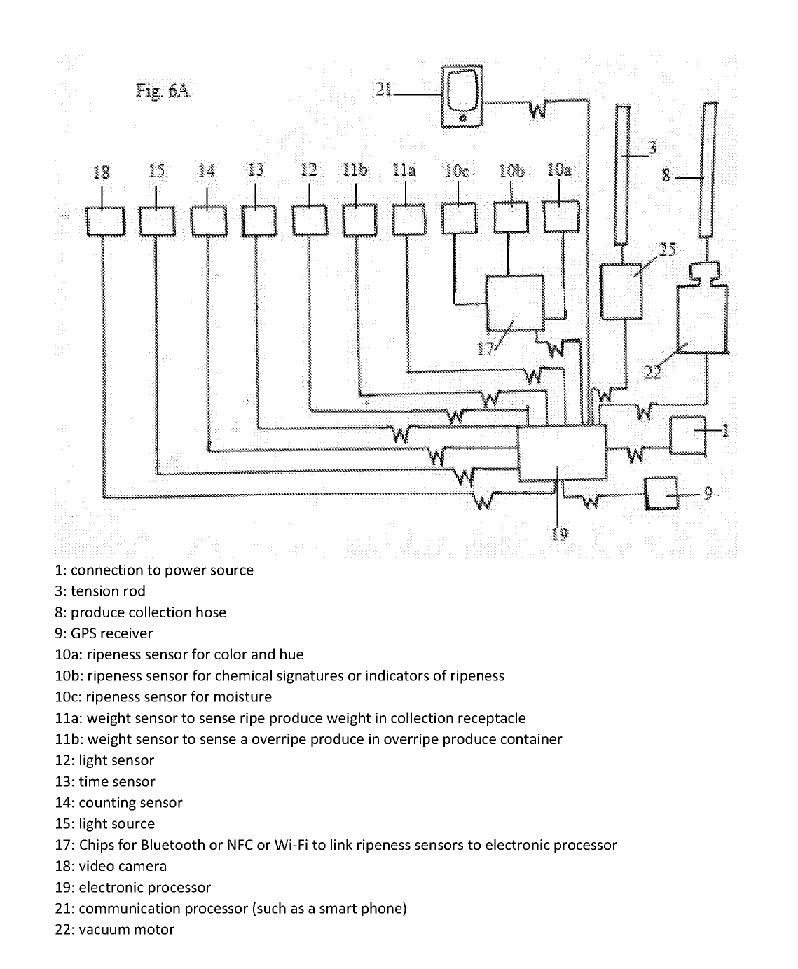

FIG. 5 is a side view showing the path of ripe and overripe produce from a growth medium into a collection nozzle, up a collection hose, into a produce channeling chute, and down a drop pipe to be routed respectively by the overripe produce lip into the ripe produce portion of the collection receptacle and the overripe produce container;

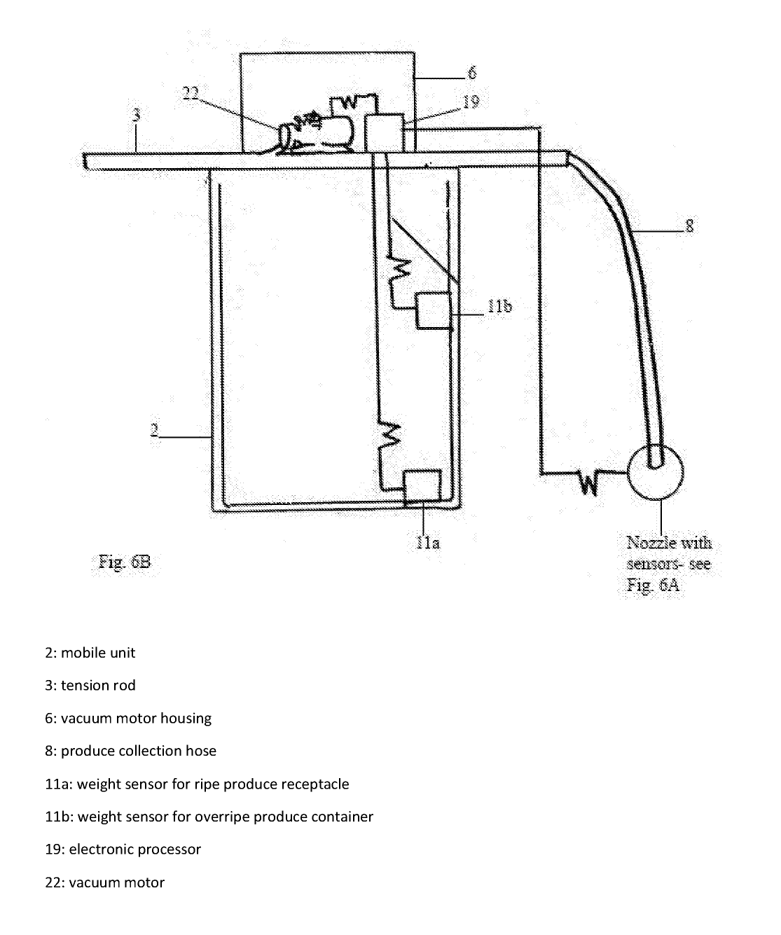

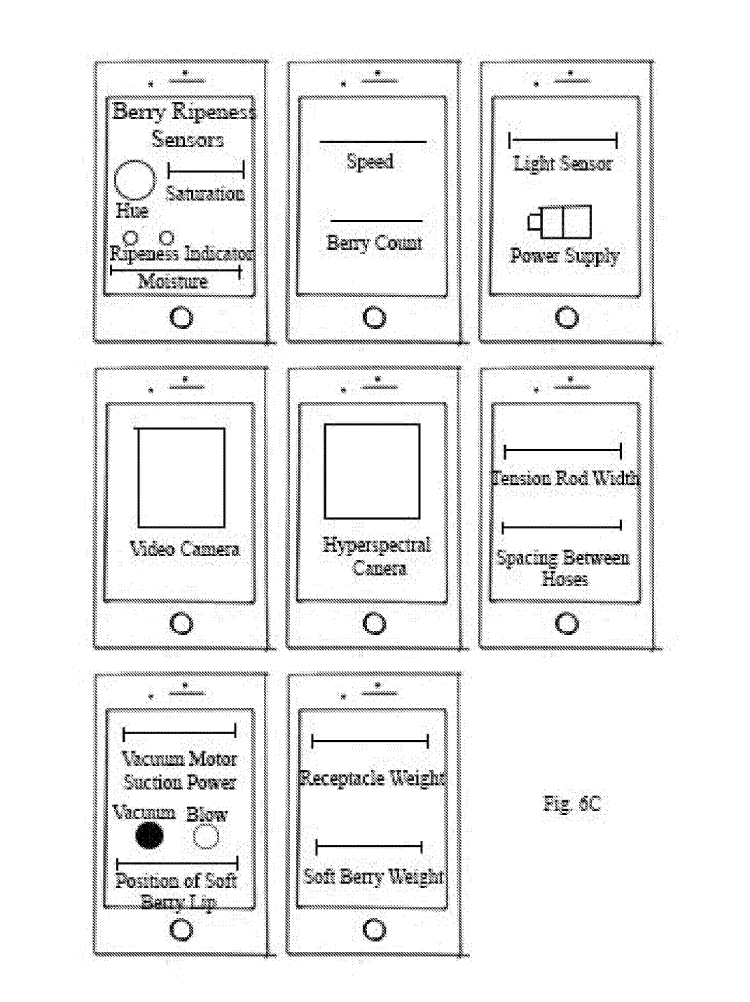

FIG. 6a is a schematic of the wireless and wired connections between the mobile communication device, the onboard processor, the sensors in the collection nozzle assembly, the camera on the collection nozzle, the light source attached to the collection nozzle, the motors to expand or contract the horizontal heavy duty adjustable tension rod, the power source for the operating assemblage, the vacuum motors, the GPS receiver on the mobile unit that carries the operational assemblage, the weight sensors under an overripe produce container and a collection receptacle and the speed sensor and unit of produce counter at the beginning of the channeling chute to route produce into a drop pipe;

FIG. 6b is a collapsed side view of the positions of the sensors relative to other components of the operating assemblage.

FIG. 6c is a set of screens for a GUI on a mobile device illustrating the configuration options and reporting displays. 6c further illustrates the capacity to label screens for different types of produce. In the illustration “berry” is substituted for “produce;” thus the label on the first screen sample is configured to read “berry ripeness sensors”, and on the second screen to read “berry count” for count of units of produce. On the seventh screen the position of the lip to capture overripe produce is labelled as “position of soft berry lip”, and the eighth screen for the weight of overripe produce is labelled as “soft berry” weight. “Speed” is the label applied for the strength of the suction from the vacuum motor to meet the conditions to overcome the tensile strength of a unit of produce to its growth medium in order for it to be harvested. A person of ordinary skill in the art will readily understand the purpose and function and instructions from the electronic processor using the Wi Fi chip set of the settings for produce ripeness sensors, the speed and unit of produce count sensors, the ambient light sensor, the video camera, the power supply, the width of the horizontal heavy duty adjustable tension rod, the spacing of the collection tube bundles on the horizontal heavy duty adjustable tension rod, the suction power of the vacuum motors, and the switch from vacuuming to blowing.

1. An operating assemblage for harvesting agricultural produce comprising a mobile unit configured to transport a produce collection apparatus through rows of growth media; said apparatus comprising at least one receptacle for collected units of produce, at least one vacuum motor with sufficient adjustable suction power to overcome the tensile connection of a ripe unit of produce to its growth media, at least one food grade collection hose to channel said unit of produce meeting criteria for harvesting from at least one sensor equipped produce collection nozzle assembly through said collection hoses and into said receptacle, at least one sensor of produce ripeness housed within said collection nozzle assembly, and at least one electronic processor configured for wireless communication with said sensor and for reception of wireless signals from a mobile communication device:
wherein said at least one sensor communicates with said electronic processor via at least one wireless communication protocol;
wherein said electronic processor communicates with the starter of said at least one vacuum motor via at least one wireless protocol;
wherein said at least one sensor is housed and contained within said at least one collection nozzle assembly;
wherein said at least one sensor is responsive to calibration instructions from said electronic processor;
wherein said vacuum motor is responsive to calibration instructions from said electronic processor;
wherein said vacuum motor suction outlet is connected to one end of a collection hose;
wherein said vacuum motor suctions said collected units of produce through at least one of said collection hose;
wherein said collected units of produce are channeled into a produce channeling chute;
wherein said produce channeling chute channels said collected units of produce into drop pipe connection to said collection receptacle;
wherein said collection receptacle is configured to accept and retain said units of produce from said drop pipe;
wherein one end of said at least one collection hose is encased by a collection nozzle; and
wherein said collection nozzle is pulled through said rows of growth media bushes by said mobile unit to enable suction to harvest said units of produce.

2. The operating assemblage as in claim 1 wherein said electronic processor is responsive to signals from said one or a plurality of said sensors housed in said collection nozzle assembly, said sensors including one or a plurality of:
a color sensor capable of detecting color saturation and hue;
a chemical sensor capable of sensing at least one chemical signature correlating with ripeness of a unit of produce;
a sensor capable of detecting ambient moisture; and
a sensor capable of detecting moisture internal to a unit of produce.

3. The operating assemblage as in claim 1 wherein said electronic processor is responsive to signals from said one or a plurality of said sensors housed in said collection receptacle, said sensors including one or a plurality of:
a timing sensor; and
a weight sensor

4. The operating assemblage as in claim 1 wherein said vacuum motor is responsive to instructions transmitted by said electronic processor:
wherein said vacuum motor is configured as a shunt motor;
wherein said vacuum motor is connected to a rheostat;
wherein said vacuum motor is responsive to an electronic signal to switch from suction mode blower mode.

5. The operating assemblage as in claim 1 wherein said mobile unit houses a wireless GPS unit configured to communicate with said electronic processor:
wherein the steering mechanism of said mobile unit is enabled to respond to directional signals via said wireless communication protocol from said electronic processor:
wherein said electronic processor accepts and transmits directional signals to said steering mechanism of said mobile device via at least one of a joystick, a GUI on a screen connected to said electronic processor, and a satellite signal transmitted to said electronic processor;
wherein said electronic processor calculates latitudes and longitudes from data transmitted by said wireless GPS unit; and
wherein said electronic processor accepts and transmits directional signals via said wireless protocol sequences of latitude and longitude instructions from maps loaded onto said electronic processor and correlated with said rows of growth media and spaces between said growth media.

6. The operating assemblage of claim 1, wherein the open portion of said one or a plurality of collection hoses is of a sufficient diameter to accept a single unit of produce being suctioned into said collection hose:
wherein momentum of a unit of produce upon exiting a collection hose carries said unit of produce into a curved deflection path;
wherein said curved deflection path feeds produce into said channeling chute;
wherein said channeling chute enables aggregation of multiple deflected units of produce from multiple collection hoses into a single stream of produce;
wherein said channeling chute routes said deflected produce into said drop pipe;
wherein said drop pipe discharges said multiple units of produce into said collection receptacle;
wherein said collection receptacle is divided into a section to accept firm produce and a section to accept overripe produce;
wherein said section of said receptacle to accept firm produce is configured to house lugs,
wherein said drop pipe is positioned at an angle to enable gravity to act upon said overripe produce;
wherein gravity and limited bounce properties reduce momentum of said overripe produce;
wherein said units of ripe produce traverse said channeling chute with greater momentum;
wherein said overripe produce move at a slower rate than ripe produce through said channeling chute;
wherein said section of said collection receptacle configured to accept ripe produce is more distant from said drop pipe than said section of said collection receptacle configured to accept overripe produce;
wherein said overripe produce loses momentum and falls into said drop pipe directly over said overripe produce section of said collection receptacle;
wherein said ripe produce retains momentum and travel a further distance to fall into said drop pipe directly over said ripe produce section of said collection receptacle;
wherein said collection receptacle houses a slide out rack;
wherein said slide out rack is on a platform within said collection receptacle;
wherein racks of said slide out rack are configured to hold a lug facing upward and to the front of said slide out rack at a 45 degree angle;
wherein said lug is rectangular with panels 4 or more inches high;
wherein the front panel of said lug facing the door of said collection receptacle is hinged;
wherein said lug is inserted into said slide out rack facing said operator with the hinged panel disconnected from the side panels and folded under the bottom of said lug;
wherein the bounce and momentum of said ripe produce carries it to said drop pipe bounces to be channeled into at least one of said angled lugs;
wherein said hinged front panel of said lug is reconnected to the sides of said lug by said operator;
wherein said operator removes said lug from said collection receptacle following collection of produce;
wherein the polygon formed by the lowest rack at a 45 degree angle of said slide out rack is covered with a top panel;
wherein a plurality of said lugs are inserted into said slide out rack prior to use of said operational assemblage to collect produce;
wherein said door is affixed to the front of said collection receptacle, said door positioned at least 12 inches in front of said slide out rack to provide said ripe produce with sufficient room to enter said upward tilted open fronted lugs;
wherein said ripe produce, upon exiting said unit of produce drop pipe falls into said receptacle and further falls into at least one lug; and
wherein said overripe produce exiting said drop pipe with insufficient momentum and bounce falls from said drop pipe into a container positioned to rest atop the first upward angled lug.

7. The operating assemblage of claim 1, wherein said collection receptacle is affixed to a backpack frame.

8. The operating assemblage of claim 1, wherein said collection receptacle is affixed to a mobile unit.

9. The operating assemblage of claim 1, wherein a plurality of said collection receptacles are affixed to a platform on a mobile unit:
wherein affixed to the top of each of said collection receptacles is one or a plurality of housings for wiring and one vacuum motor;
wherein one end of said collection hoses is attached to each vacuum motor;
wherein the opposite end of said collection hose is encased in a sensor equipped nozzle assembly;
wherein a rigid support channel for a horizontal heavy duty adjustable tension rod is affixed to the connecting intersection of multiple collection receptacles;
wherein said horizontal heavy duty adjustable tension rod is fitted into said rigid support channel;
wherein said horizontal heavy duty adjustable tension rod extends on both ends;
wherein a motor connected to gears that ratchet the extendable parts of said horizontal heavy duty adjustable tension rod to lengthen or contract the width of said horizontal heavy duty adjustable tension rod;
wherein said motor to lengthen and contract the width of said horizontal heavy duty adjustable tension rod is responsive to Wi-Fi signals and width calibration instructions from said electronic processor;
wherein said horizontal heavy duty adjustable tension rod is of sufficient length to extend beyond a bush in a row to the left of said mobile unit and beyond a bush to the right of said mobile unit as said mobile unit travels between 2 rows of growth media;
wherein a plurality of said collection hoses are affixed to said horizontal heavy duty adjustable tension rod;
wherein said nozzle assembly attached to each of said collection hoses hangs downward from said horizontal heavy duty adjustable tension rod;
wherein said plurality of nozzle assemblies shifts along said horizontal heavy duty adjustable tension rod as the width of said horizontal heavy duty adjustable tension rod is adjusted via telescoping such that said plurality of nozzle assemblies are positioned to intersect growth media at multiple points;
wherein, as said mobile unit travels between 2 rows of growth media, said plurality of nozzle assemblies rakes through said growth media to discover, encompass, and suction ripe produce into said receptacle.

10. The operating assemblage of claim 1, wherein said electronic processor adjusts the amount of suction generated by said vacuum motor sufficient to overcome the tensile strength of a connection of a unit of produce to growth media;
wherein said operator sets a value for an increase in the weight of produce in the collection receptacle registered by a weight sensor placed into said collection receptacle per unit of time; and
wherein said electronic processor continuously calibrates and instructs the vacuum motor to generate sufficient suction to achieve said value for an increase in the weight of produce in the collection receptacle.

11. The method for use of said operating assemblage of claim 1, wherein an operator of said assemblage calibrates parameters for assessment of the ripeness of a unit of produce by said one or a plurality of sensors through a GUI on a mobile electronic device; and
wherein said operator selects one or a plurality of units of produce from growth media to use as a baseline for said calibration by said one or a plurality of sensors.

12. The method of claim 11, wherein said operator of said assemblage manually directs said nozzle assembly to partially encase a portion of growth media for one or a plurality of said sensors to identify a unit of ripe produce upon one or a plurality of growth media.

13. The method of claim 11, wherein said one or a plurality of sensors in said nozzle assembly, upon identification of at least one ripe berry, triggers said vacuum motor to start.
